(19) United States
(12) Patent Application Publication
(10) Pub. No.: US 2014/0315623 A1
(43) Pub. Date: Oct. 23, 2014

(54) System And Method For Marketing A Product

(71) Applicant: Joseph A. Bonavita, Oxford, CT (US)

(72) Inventor: Joseph A. Bonavita, Oxford, CT (US)

(21) Appl. No.: 14/011,944

(22) Filed: Aug. 28, 2013

Related U.S. Application Data
(60) Provisional application No. 61/814,997, filed on Apr. 23, 2013.

(51) Int. Cl. A63F 13/30

(52) U.S. Cl. CPC A63F 13/12
USPC 463/25

(57) ABSTRACT

A system for marketing a product includes a storage having information on games and prizes. A server in electronic communication with the storage receives information on a submitted prize over a network and stores it in the storage as one of the prizes. The server assigns a monetary value to each of the prizes and offers them to players. The server sells tickets to the players for the chance to win a selected prize, using the monetary value associated with the selected prize to calculate a preferred number of tickets to sell, each of the tickets having at least one game play. The server offers at least one of the games for play in return for game play(s) and identifies a winner of the selected prize based at least in part on the results.

### FIELD OF THE INVENTION

The present teachings relate generally to product marketing and, more particularly, to systems and methods for marketing a product using a competition.

### BACKGROUND OF THE INVENTION

When economies become stagnant and unemployment rises, people become more and more financially strapped for cash. As a result, they spend and buy less. In order to increase their customer bases and sell their products, businesses need to become more creative in how they market, sell and finance their products.

One way a business tries to increase its customer base is by running sales and decreasing prices for popular products. Another way is by providing liberal financing to customers, such as “no money down” offers, “rent to own” offers, and by providing financing regardless of credit history. However, these approaches have the potential to be disastrous for the business, the customer, or both. For example, businesses can suffer because they are carrying potentially bad debt, while customers can suffer because they are at risk of getting in debt that they are not capable of repaying.

Still another way some businesses (and individuals) use to sell a product involves raffles, where tickets are sold for a chance to win a product. For example, there have been raffles where tickets are sold for a chance to win a house. The tickets are typically priced affordably and the raffle based on a minimum number of tickets being sold. Thus, the owners of the house are able to sell their house while the winning ticket holder gets the house. This type of approach would seem to be ideal in that both the seller and the buyer benefit.

However, there are laws that restrict certain types of raffles and that prevent this type of product promotion from being practical. Further, it may not be preferable to identify a winner based purely on chance. Accordingly, what is needed is a superior system and method for marketing and selling a product.

### SUMMARY OF THE INVENTION

The needs set forth herein as well as further and other needs and advantages are addressed by the present embodiments, which illustrate solutions and advantages described below.

The system of the present embodiment includes, but is not limited to, a storage having information on a plurality of games and information on a plurality of prizes, and a server computer in electronic communication with the storage. Storer software executing on the server computer receives information on a submitted prize over a network and stores it in the storage as one of the plurality of prizes. Value assigner software executing on the server computer assigns a monetary value to each of the plurality of prizes. Prize offer software executing on the server computer offers the plurality of prizes to a plurality of players. Ticket seller software executing on the server computer sells tickets to the plurality of players for the chance to win a selected prize of the offered plurality of prizes, the ticket seller software using the monetary value associated with the selected prize to calculate a preferred number of tickets to sell, each of the tickets having at least one game play. Game offering software offers at least one of the plurality of games for play in return for at least one game play. Winner identifier software identifies a winner of the selected prize based at least in part on results of the play of the at least one of the plurality of games.

The storage may comprise a plurality of databases in electronic connection with each other and the server computer may comprise a plurality of computers in electronic connection with each other.

The system may further comprise submitter software executing on a submitter computer, the submitter software sending the information on the submitted prize to the storer software.

The system may further comprise at least one web page having a graphical user interface for the prize offer software, ticket seller software and game offering software.

The system may further comprise a mobile device application executing on a player computer, the mobile device application having a graphical user interface for the prize offer software, ticket seller software and game offering software.

The value assigner software may determine the monetary value based on one or more attributes of the submitted prize. The monetary value may include an administrator fee.

The game offering software may not offer the at least one of the plurality of games for play until the preferred number of tickets are sold.

The system may further comprise approver software executing on an approver computer, the approver software approving the information on the submitted prize so that the submitted prize can be offered by the prize offerer software. The approver computer and the server computer may comprise different computers.

The at least one of the plurality of games may comprise a plurality of games offered in a plurality of rounds of game play(s). Different games may be played in each of the plurality of rounds. A player may skip a round in return for paying an additional fee.

Players may pay additional fees for game hints, to play an easier game, or for bonus features.

Tickets have an expiration date before which their associated game plays must be used.

The monetary value of the submitted prize may be provided by the prize owner.

In another embodiment, the system of the present embodiment includes, but is not limited to, a storage having information on a plurality of games and information on a plurality of prizes. A server computer is in electronic communication with the storage. Storer software executing on the server computer receives information on a submitted prize over a network and stores it in the storage as one of the plurality of prizes. Submitter software executing on a submitter computer sends the information on the submitted prize to the storer software. Value assigner software executing on the server computer assigns a monetary value to each of the plurality of prizes. Prize offer software executing on the server computer offers the plurality of prizes to a plurality of players. Ticket seller software executing on the server computer sells tickets to the plurality of players for the chance to win a selected prize of the offered plurality of prizes, the ticket seller software using the monetary value associated with the selected prize to calculate a preferred number of tickets to sell, each of the tickets having at least one game play. Game offering software offers at least one of the plurality of games for play in return for at least one game play. At least one web page has a graphical user interface for the submitter software, prize offer software, ticket seller software and game offering software. Winner identifier software identifies a winner of the selected prize based at least in part on results of the play of the at least one of the plurality of games.

The method of the present embodiment includes the steps, but is not limited to, storing on a storage information on a plurality of games and information on a plurality of prizes; providing a server computer in electronic communication with the storage; receiving information on a submitted prize over a network and storing it in the storage as one of the plurality of prizes; assigning a monetary value to each of the plurality of prizes; offering the plurality of prizes to a plurality of players; selling tickets to the plurality of players for the chance to win a selected prize of the offered plurality of prizes using the monetary value associated with the selected prize to calculate a preferred number of tickets to sell, each of the tickets having at least one game play; offering at least one of the plurality of games for play in return for at least one game play; and identifying a winner of the selected prize based at least in part on results of the play of the at least one of the plurality of games.

The method may further comprise sending the information for the submitted prize from a submitter computer.

The method may further comprise the step of approving the information on the submitted prize so that the submitted prize can be offered by the prize offerer software.

At least one of the plurality of games may comprise a plurality of games offered in a plurality of rounds of game play(s).

The step of offering at least one of the plurality of games for play may not occur until the preferred number of tickets is sold.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic block diagram depicting one embodiment of a system for marketing a product according to the present teachings.

FIG. 2 is a block diagram depicting one embodiment of a method for offering a product according to the system of FIG. 1.

FIG. 3 is a block diagram depicting one embodiment of a method for winning a product according to the system of FIG. 1.

FIG. 4 is a schematic diagram depicting a tier bracket for marketing a product according to the system of FIG. 1.

FIGS. 5-9 are screen shots depicting embodiments of the graphical user interface according to the system of FIG. 1.

FIGS. 10-16 are schematic block diagrams depicting embodiments of games for play according to the system of FIG. 1.

FIG. 17 is a block diagram depicting one embodiment of a method for playing a combination game according to the system of FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In one embodiment according to the present teachings, a method for marketing a product as a prize is provided. This method includes obtaining an item to be distributed as a prize, setting a value to the item, selling tickets to allow competitors to compete for the item, determining at least one game to be played by the competitors for the prize, playing the at least one game until a winner of the at least one game is identified, and distributing the item to the winner.

In another embodiment, machine readable computer program code encoded onto a storage medium is provided where the program code includes instructions for causing a controller to implement a method for marketing a product as a prize. The method includes obtaining an item to be distributed as a prize, setting a value to the item, selling tickets to allow competitors to compete for the item, determining at least one game to be played by the competitors for the prize, playing the at least one game until a winner of the at least one game is identified, and distributing the item to the winner.

In still another embodiment, a computer system having an input device, an output device and at least one processing device is provided. The at least one processing device is configured to implement a method for marketing a product as a prize. The method includes obtaining an item to be distributed as a prize, setting a value to the item, selling tickets to allow competitors to compete for the item, determining at least one game to be played by the competitors for the prize, playing the at least one game until a winner of the at least one game is identified, and distributing the item to the winner.

The present teachings provide a new method for distributing a product, such as a house, as a prize. Any type of prize may utilize the present teachings, which are not limited to any particular embodiment disclosed herein.

It is to be appreciated that the method of the present invention is advantageously more practical and easier to implement than prior methods. In addition, it may not be not subject to the rules that govern lotteries. In accordance with one embodiment of the present teachings, the method generally includes selecting an item to be “won” and assigning that item as a prize to be given to the winner of one or more games selected from a group of games. The game(s) may also be preselected for a specific prize. For example, prizes may be matched or assigned to specific game(s). Moreover, it should be appreciated that the method of the invention, in whole or in part, may be administered via a computer system and practiced in a virtual environment (e.g., over the Internet or other network such as WAN, LAN, etc.).

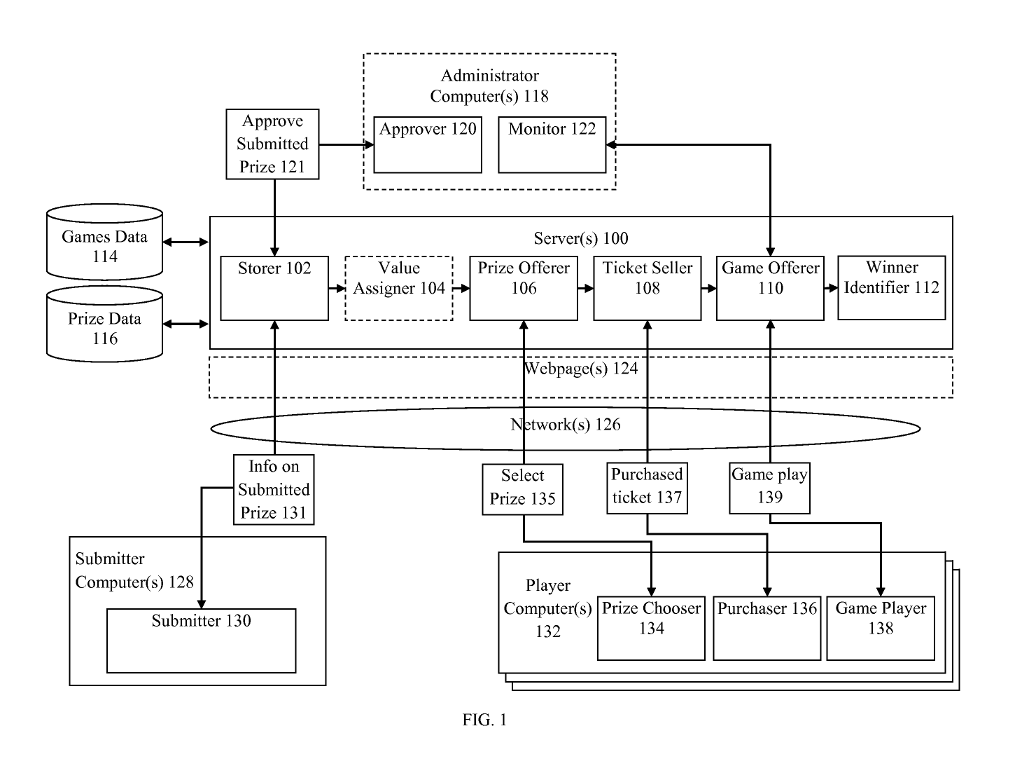

Referring now to FIG. 1, shown is a schematic block diagram depicting one embodiment of a system for marketing a product according to the present teachings. As shown, the methods of the present teachings may be implemented in a system comprising physical components such as computers and databases, as well as associated software. In one embodiment, a server 100 may have software executing on computer-readable media for communicating with other computers in the system and for performing computations. Any of the functional blocks depicted in FIG. 1 may be implemented in software executing on hardware (e.g., computer processor, etc.), although not limited thereto.

As shown, server 100 may be in electronic communication over a network 126 such as the Internet with submitting computer(s) 128. Submitting computer(s) 128 allow a user to submit a prize for offering on the system, although not limited thereto. In one embodiment, users may access the system through a webpage 124. However, in other embodiments users may utilize smart phone applications and other forms of user interfaces. What is desired is to provide an interface for permitting users to access functionality on the sever 100 and the present teachings are not limited thereto.

A submitter 130 on the submitting computer 128 may allow a user to submit information 131 about a prize for marketing on the system. The submitter 130 may allow uploading (e.g., transmitting) of the prize information (and any related information, although not limited thereto) to a storer 102. The storer 102 may then store the prize information in a prize data database 116, although not limited thereto.

An administrator computer 118 may have an approver 120 for approving the prize submission with an approval 121 (or rejection, etc.). In one embodiment, an administrator may use the approver 120 to review and approve prize submissions. In another embodiment, the system may alternatively approve and reject submissions automatically based on predetermined criteria. For example, the prize value may have to fall within a predetermined range for a prize category, only certain prize categories (e.g., vehicles, electronics, real estate, etc.) may be accepted, etc. What is desired is the ability to approve prize submissions, whether manually by an administrator, or automatically based on predetermined guidelines and the present teachings are not limited to any particular embodiment disclosed herein.

A value assigner 104 may assign a value to the prize. This may be based upon a value provided by the user, or determined based on the item. For example, in one embodiment, the system may calculate the value of a prize based on its manufacturer, model number, age, etc. This may include searching a network (e.g., Internet, etc.), database, or interacting with some shopping service to determine a fair market value of the prize, although not limited thereto.

Once the value of the prize is determined, it may be offered to game players by a prize offerer 106. The prize offerer 106 may provide all prizes available to be won on the system, whether categorized by time of submission, submitter, prize category, value, etc. What is desired is for a player to be able to search/locate a prize of interest so that the player can select a prize 135 with the prize chooser 134, although not limited thereto. Items can be listed by the administrator of the site as well as third parties (e.g., site partners, etc.), although not limited thereto.

Prizes can include material items such as houses, cars, boats, jet skis, motorcycles, etc. Prizes may also include timeshares (either for the title of the share or a single week, etc.), iPods, iPhones, other tablets and smartphone's, other electronics such as TV's, computers, laptops, etc. Prizes may also include cash prizes, mortgage pay offs (from $0 to the total amount owed or any anywhere in between), tickets to concerts, tickets to movies, furniture, appliances, etc. It is to be appreciated that any good or service may be offered as a prize with the current teachings, which are not limited to any particular embodiments disclosed herein. The present teachings may be utilized by businesses to reduce inventory or add a new revenue stream, or to raise money for charity, although not limited thereto.

Once a player has selected a prize, the player may be offered tickets by a ticket seller 108. The ticket seller 108 may determine a minimum (or maximum, etc.) number of tickets to be sold, the ticket price, etc. A player (e.g., system user) may purchase one or more tickets 137 with the purchaser 136, although not limited thereto.

Typically, a minimum number of tickets to be sold (so that the owner of the prize and the administrator receives their desired amounts) would be determined based on a variety of parameters. In one embodiment, the minimum number of tickets that need to be sold may be based on the dollar amount of the prize (as set by the owner of the prize and/or the administrator, system, etc.) plus any desired fees or profits. For example, consider the situation where the owner of the prize wants to obtain $180,000 for a prize, the administrator is charging a $1000 fee, and the tickets are being sold for $50. In this case, a minimum of 3,620 tickets should be sold prior to the game being played (3,620*50=181,000). In one embodiment, an administrative fee charged for offering a prize for sale on the system may be fixed (e.g., a $100 fee, 10% of amount sought for prize, etc.), although not limited thereto.

In one embodiment, a submitter may allow for bartering for tickets, for example, by receiving in kind goods or services. Players (e.g., users) on the system may also trade tickets among themselves. In another embodiment, players may play a game to enter a drawing. For example, all players that reach 10,000 points (or some other predetermined threshold) will be entered in the contest.

The value of tickets to be sold may be predetermined based on the prize, prize category, submitter preferences, administrator preferences, or some other guidelines. For example, it may be preferable to price tickets as low as possible in order to encourage ticket sales. Certain categories may have predetermined ticket values, such as $1 for electronics, $5 for vacations, $10 for recreation vehicles, $20 for other vehicles, $50 for boats, and $100 for real estate, although not limited thereto.

In one embodiment, players may earn or be awarded tickets. For example, if a player purchases a predetermined number of tickets (or value), the player may be given additional tickets to play for the same or a different prize. In this way, if a player purchases $100 in tickets (or some other predetermined amount), they may be given an extra $2 in tickets (or some other predetermined amount). Tickets may also be awarded for game play(s) (length of play, high score, second place, etc.).

In some cases the administrator may let the game be played as long as enough tickets are sold to cover the amount the owner wants (without any additional fee). In other cases, the submitter/owner (or the administrator, etc.) may lower the desired amount for the prize if not enough tickets were sold. For example, in the above example where the owner of the prize would like to get $180,000 for the item but only enough tickets were sold that the owner would receive $178,000, the administrator may allow the owner to chose to let the prize be offered.

Once a player purchases a ticket, the game offerer 110 may offer games for the player to play 139 with the game player 138. The offered games may be predetermined by the submitter, by the administrator, or randomly selected by the system, although not limited thereto. The games data database 114 may have a number of categories of games, some of which are described in more detail below. What is desired is for players to compete with each other by playing one or more games in order to win the selected prize. Game play(s) may be obtained by purchasing ticket(s).

In one embodiment, an administrator may monitor 122 game play(s). For example, the administrator may watch the games being played or the results of games to minimize the risk of cheating by the players. The administrator may also approve a winner, although not limited thereto. In one embodiment, players may win account points from playing games that can be applied to other games for either free or discounted play.

In one embodiment, players may earn points which can be retained (e.g., stored in their account, etc.). Once a player has accumulated enough points, the player may apply them to “purchase” a prize. For example an iPad may be worth 5000 points (or some other predetermined value, etc.). By completing each round of a game a player may accumulate a certain number of points (e.g., 100 points per round, etc.). At the end of a game if a player has finished 5 rounds the player may have earned 500 points. These points could be stored in the player's account and combined with points earned from playing other games until the player reaches the total points needed to exchange for an item.

The winner identifier 112 may calculate the results of one or more games and identify a winner. This may be based on the results of a single game, overall score of multiple games, etc. The results may need to be approved by an administrator before a prize is distributed.

Identification of a winner may be performed in any number of different ways, as would be appreciated by one skilled in the art. For example, the highest score of a single game may be used, highest average score over multiple games, longest play time, highest round achieved, etc. The present teachings are not limited to any particular embodiment disclosed herein. What is desirable it to be able to identify a winner based at least in part on the winner's game play(s).

In one embodiment, the system according to the present teachings may include a title transfer module. In this way, the system (or administrator, etc.) may verify ownership (also, e.g., condition, model number, etc.) of a prize before offering it. The system may facilitate title transfer of the prize from a submitter to a prize winner. This may include the providing of forms and other legal papers for title transfer. In another embodiment, the submitter may assign ownership of a prize to the system, which may then in turn assign it to a prize winner.

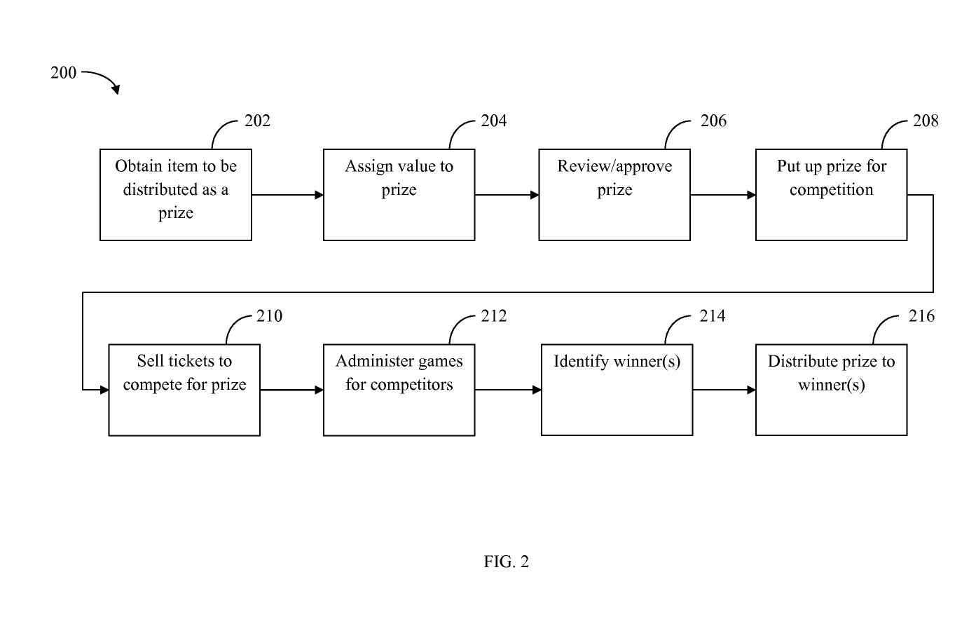

Referring now to FIG. 2, shown is a block diagram depicting one embodiment of a method 200 for offering a product according to the system of FIG. 1. An administrator may obtain an item for distribution as a prize, as shown in operational block 202. Obtaining an item for distribution as a prize, as shown in operational block 202, may be accomplished via a variety of methods. For example, in one embodiment an item may be submitted to the administrator by an individual or a business for consideration as a prize. In this case, the submission may be accomplished via an on-line submission or via a paperwork/in-person submission, although not limited thereto. When an item is submitted for consideration, the administrator may require the submitter to provide information about that item, such as a description of the item (type, age, any defects, etc.) and proof of ownership. What information is required may be determined by the administrator.

Setting a value for the item, as shown in operational block 204, may be accomplished by the submitter or by the administrator, although not limited thereto. For example, when the submitter submits the item for consideration, the submitter may submit a desired minimum price. Or the submitter may allow the administrator to set the minimum price, although not limited thereto.

At this point, the submitted item may be reviewed for approval, as shown in operational block 206. During this review process, the administrator may review the item to see whether it satisfies parameters that may be predetermined by the administrator. These parameters may include quality levels, ownership issues, legal risk considerations, and/or sales considerations, although not limited thereto. For example, if the submitter wants to obtain a minimum amount for the item, the submitter may inform the administrator.

If the administrator believes that the item will not sell the required number of tickets needed to achieve the minimum amount (or if the administrator thinks the minimum price set by the submitter is too low or too high, etc.), then the administrator may determine the minimum amount. If the submitter doesn't agree with the administrator, then either the submitter may withdraw the item from consideration, or the administrator may refuse to approve the item for competition. For example, if the administrator fee is based on the amount desired for the prize and the owner is setting the amount for the prize at an amount that is lower than the administrator believes the prize can generate (e.g., via ticket sales), then the administrator may refuse to approve the item for competition.

If the item is not approved by the administrator, then the item may be removed from consideration. However, if the item is approved, then the item may be put up for competition and tickets are sold to potential competitors, as shown in operational blocks 208 and 210.

Upon approval, the prize may then be put up for competition, as shown in operational block 208, where potential competitors are able to purchase tickets to compete for the prize, as shown in operational block 210.

It should be appreciated that the price of the tickets may be based on various parameters, such as the minimum desired amount and/or the number of tickets expected to be sold. For example, if the minimum desired amount is $100,000 and the expected number of tickets to be sold is 1,000 tickets, then the price of the tickets may be set at $100 per ticket. It should be appreciated that the tickets may be sold on the basis of a maximum number of tickets or the tickets may be sold for a predetermined period of time. However, if the minimum number of tickets required is not sold, the item may be removed from consideration and refunds may be issued for the tickets already sold. It should be appreciated that the price of the tickets may be based on other parameters as desired. For example, if the competitor wants to play easier games (or easier game levels, etc.) then the price of the tickets may be higher than if the competitor is playing harder games, although not limited thereto.

Once a predetermined minimum number of tickets are sold to competitors, one or more games will be provided by the administrator for the competitors to compete in against each other, as shown in operational block 212. Once the competition is completed, the administrator may identify the winner and distribute the item to the identified winner, as shown in operational blocks 214 and 216. It should be appreciated that a winner (or winners) may be identified based on a score value achieved throughout the game, or the winner may be identified based on accomplishments achieved throughout the game. Moreover, competitors may purchase (or earn, etc.) hints or bonus features of the game.

In one embodiment, a submitter may submit for competition a lot of multiple prizes. In this case, there may be multiple winners, with each winner receiving one or more of the prizes from the lot.

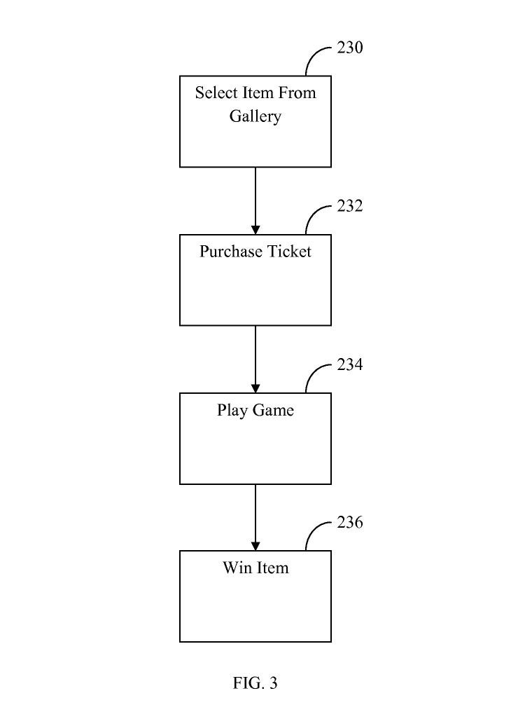

Referring now to FIG. 3, shown is a block diagram depicting one embodiment of a method for winning a product according to the system of FIG. 1. As shown, a player (e.g., user) may first select an item from the gallery 230 (e.g., a prize to be won). Then the user may purchase a ticket 232. The user then plays a game 234 and wins an item 236 if successful in game play(s).

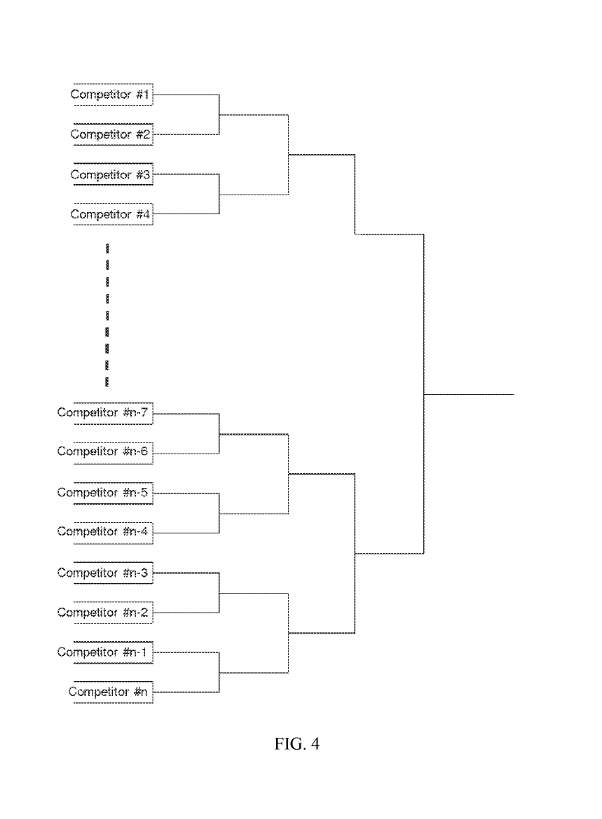

Referring now to FIG. 4, shown is a schematic diagram depicting a tier bracket for marketing a product according to the system of FIG. 1. Once the sales of the tickets are closed, the competition for the item begins, and the administrator may run/administer the game(s) played by the competitors. In one embodiment, the games may be played on a single-tiered or multi-tiered basis until one winner emerges. In one embodiment, players may only move to the next tier if they get a minimum score, or only a predetermined subset of players may move on the next tier, although not limited thereto.

It should also be appreciated that a competition for an item may include the competitors playing different games. For example, the competitors may play a first game in a first tier, a second game in a 2nd tier, a third game in a 3rd tier and so on, where each of the games may be different and the games may or may not increase in difficulty. Additionally, if desired and allowed by the administrator, in some situations competitors may skip tiers based on the payment of additional fees or previous game play(s), although not limited thereto. Competitors may also be allowed to play easier games based on the payment of additional fees. The games to be played by competitors may be selected by the administrator, by the system (e.g., based on predetermined guidelines, etc.), or by the submitter, although not limited thereto.

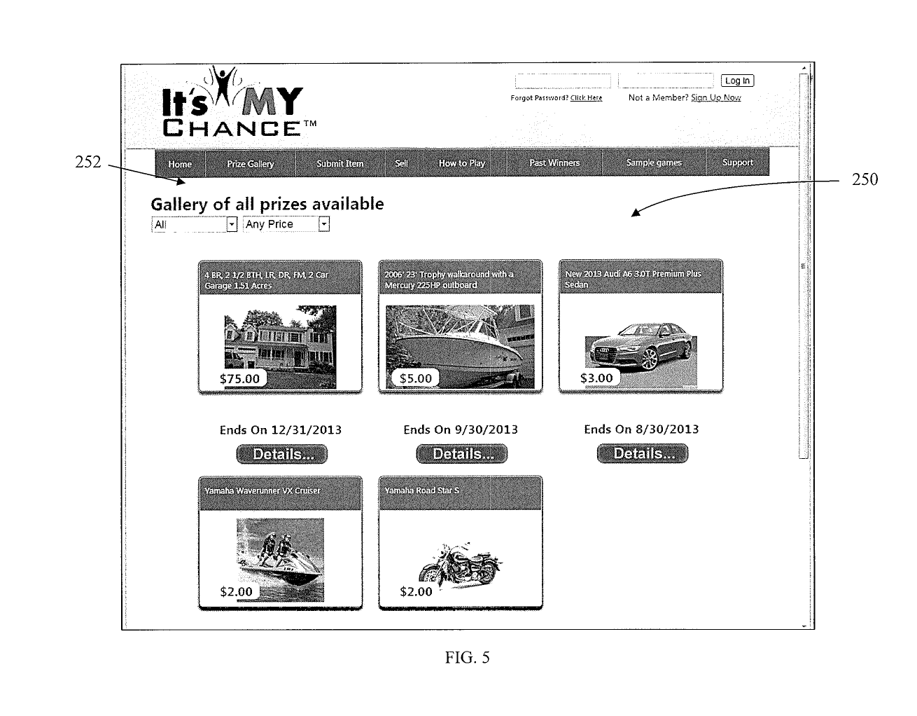

Referring now to FIGS. 5-9, shown are screen shots depicting embodiments of the graphical user interface according to the system of FIG. 1. As shown in FIG. 5, a gallery 250 of available prizes may be presented to the players (e.g., prize offerer 106 and chooser 134 shown in FIG. 1). A player (e.g., user, etc.) may sort for prizes based on category, price, or any other attribute using filters 252. A player can get detailed information about any prize. Ultimately, a player selects a prize the player is interested in winning. This may be accomplished by clicking on the selected prize, although not limited thereto.

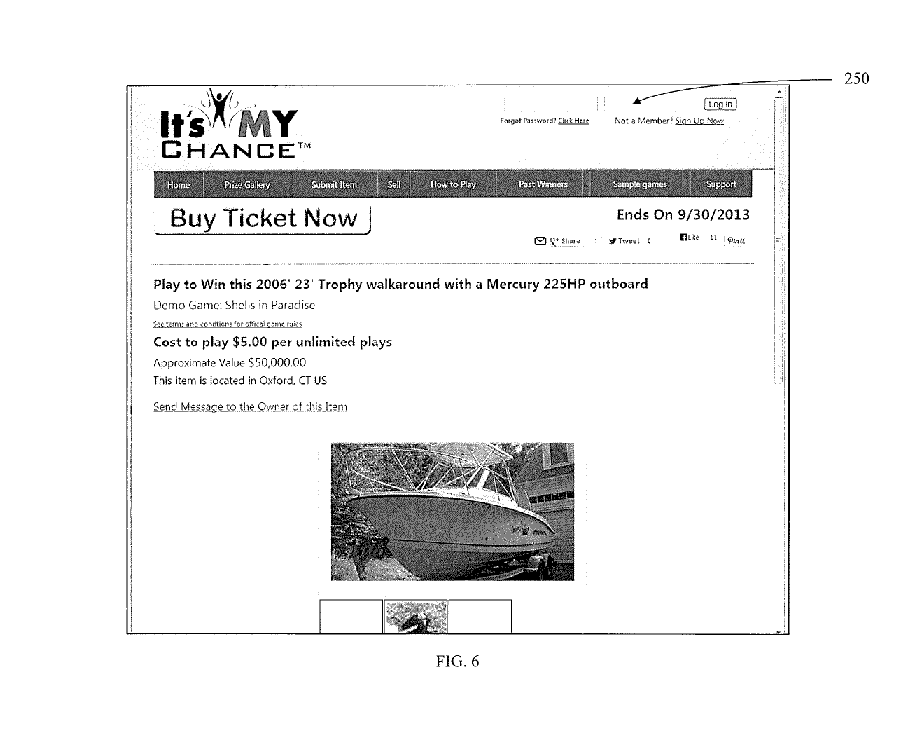

Referring now to FIG. 6, once a player has selected a prize the player may purchase one or more tickets (see, e.g., ticket seller 108 and purchaser 136 in FIG. 1). After purchasing a ticket, the player is able to play game(s) for the prize.

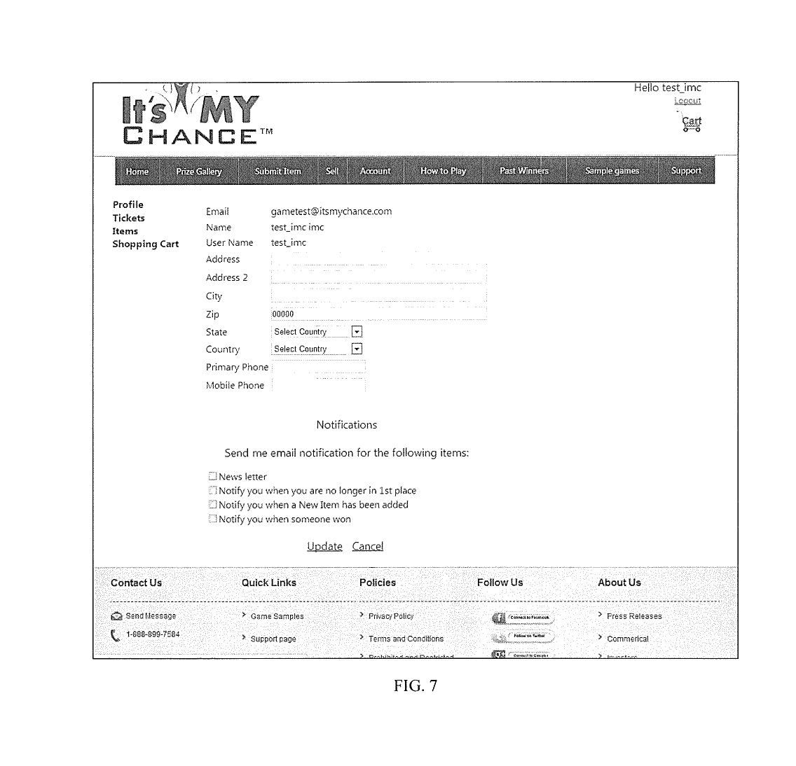

Referring now to FIG. 7, a player may store account information (e.g., contact, payment information, etc.) by creating an account on the system. This information may be stored in one or more databases (114, 116 in FIG. 1). The player may access their information by logging in 260 (shown in FIG. 6) with a username and password, although not limited thereto.

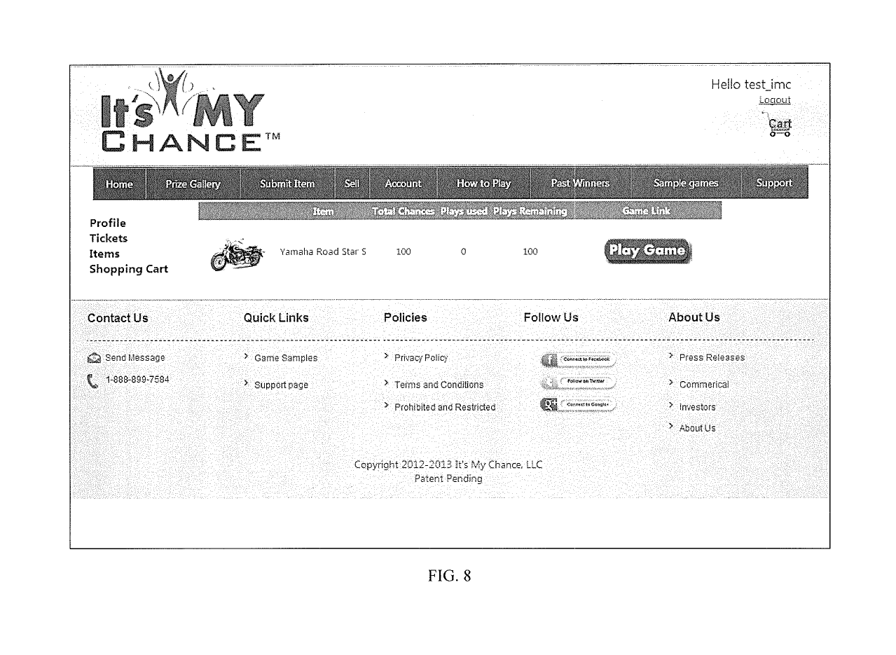

Referring now to FIG. 8, a player's account may store information on all of the tickets the player has purchased. Once a ticket has been acquired (e.g., from purchasing, receiving free, etc.), the game(s) for that competition can be played at any time before the end date of the game. This way, the player can access the system intermittently in order to play a game for one or more prizes. Each ticket purchased may provide for a predetermined number of plays (e.g., 1, 10, 100, etc.).

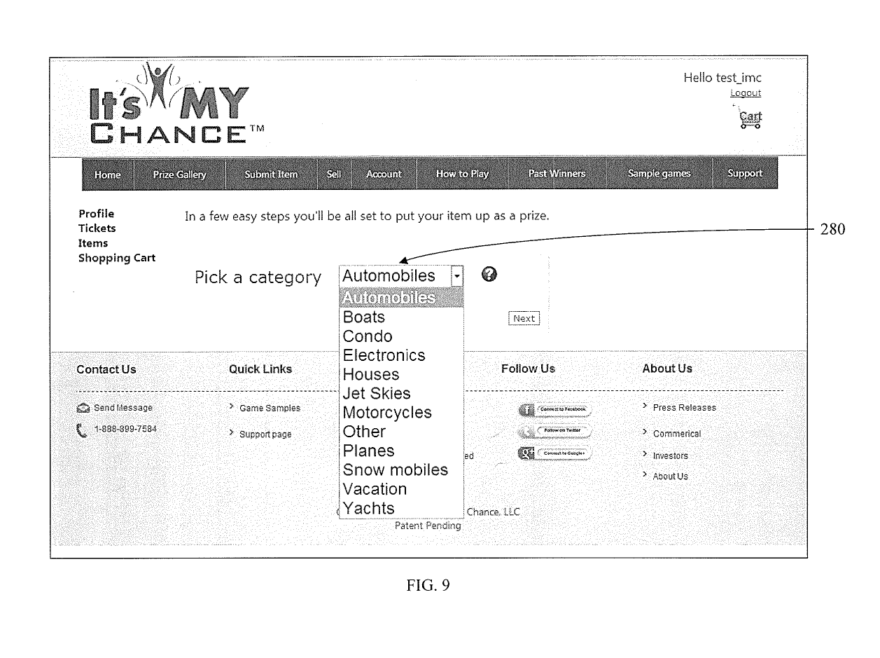

Referring now to FIG. 9, a user (e.g., player) may submit an item to offer as a prize (e.g., submitter 130 and storer 102 in FIG. 1). This may include selecting a category 280 for the prize to be offered.

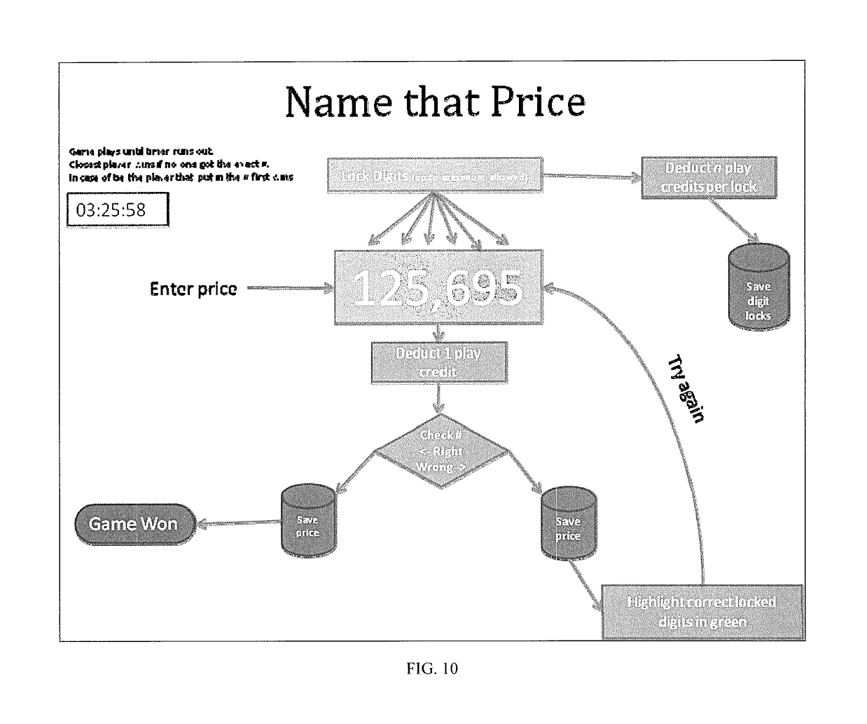

Referring to FIGS. 10-16, shown are schematic block diagrams depicting embodiments of games for play according to the system of FIG. 1. It should also be appreciate that commonly known games, such as “Hang Man” or “Scrabble®” may be played, or new games may be created.

Referring to FIG. 10, one game that may be played includes a game called “Name that Price.” In this game, the winner is the first one to enter the right price. The player will also be able to lock in correct guesses by buying digit locks. For example if the player is playing for a house and the house costs $112,456, the user can buy up to 3 digit locks. The user may decide to lock in digits 1, 3, and 4 (from left to right). When the user guesses a correct digit, the digit may be displayed in green.

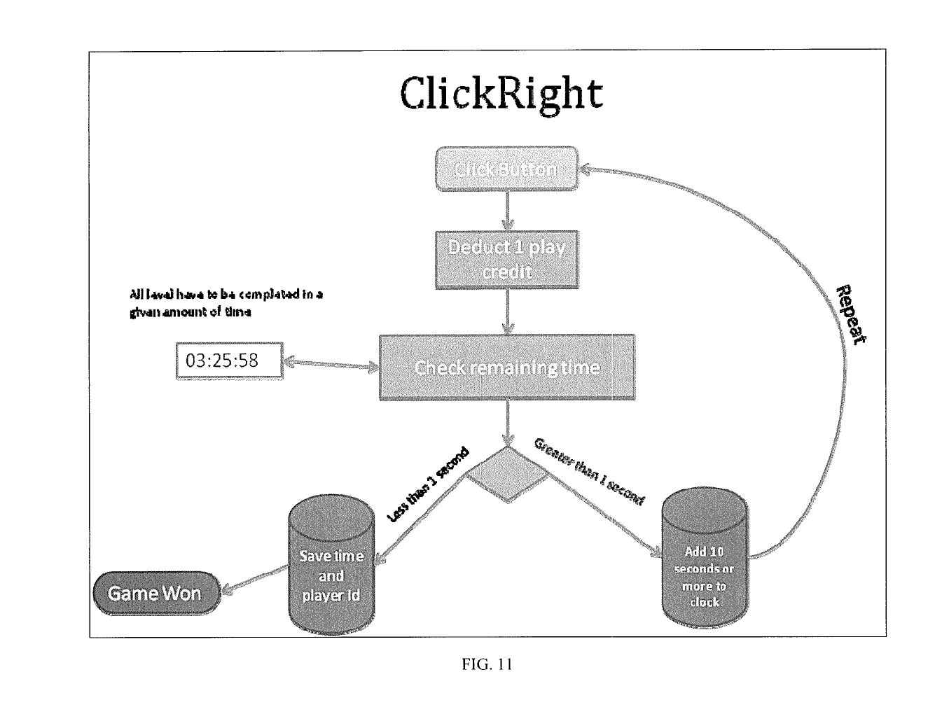

Referring to FIG. 11, another game that may be played includes a game called “ClickRight.” In this game, the winner is the last one to click the button and win. Each time the button is clicked it may add a predetermined amount of time to the clock (e.g. 10 seconds, etc.). This may happen every time the button is clicked if there is a predetermined amount of time (which may be selected as desired, such as 1 or more seconds, etc.) remaining on the clock. If the player clicks it and there is less than the predetermined amount of time on the clock, then no additional time will be added. The last one to have clicked the button may win.

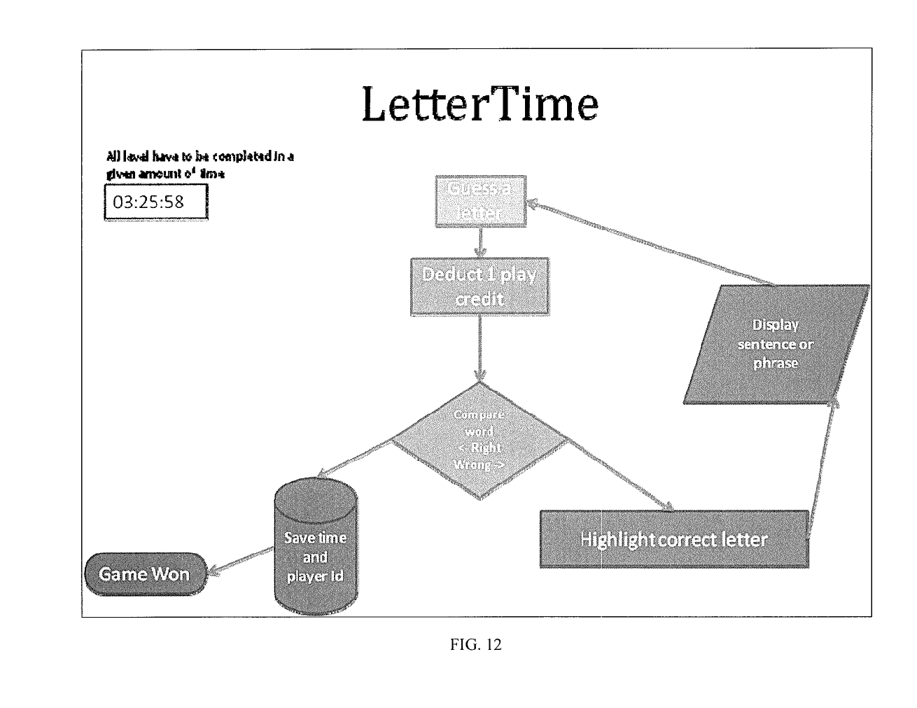

Referring to FIG. 12, yet another game that may be played includes a game called “LetterTime.” This game may be similar to “hang man” in that the players will have to pick letters. Each pick may use one play. Users may purchase hints for 2-5 plays, although not limited thereto. There may be a timer and multiple levels to complete. The first to finish all the levels may win.

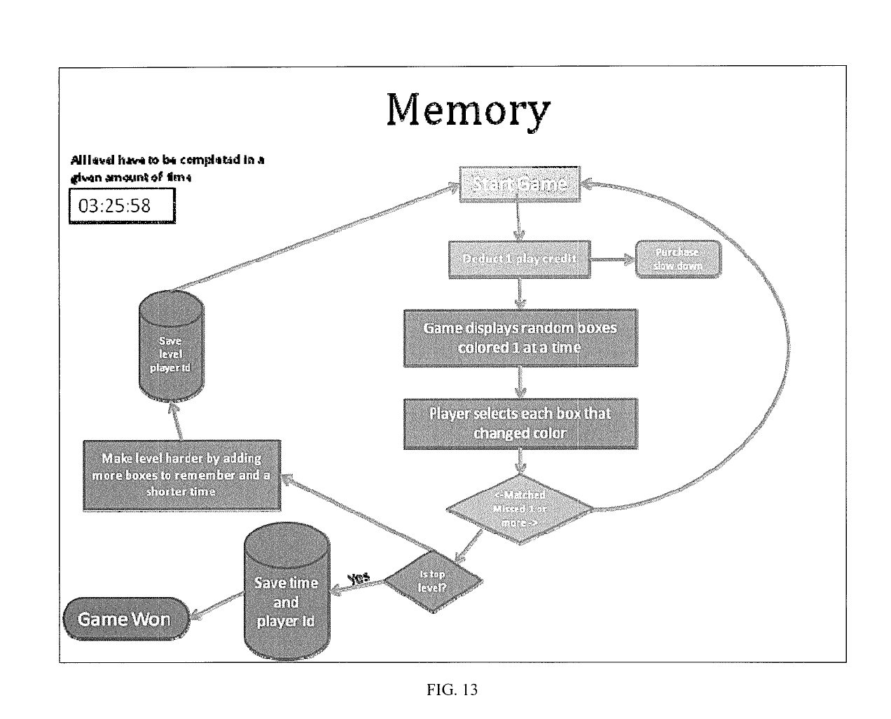

Referring to FIG. 13, still another game that may be played includes a game called “Memory.” In this game, the user may click the boxes in the order that they are lit up. For example, the game may start with a 4×4 grid and go up to an 8×8 grid. Each level may have 5 or more sets to get through before moving on, where the first player to finish all the levels wins. If a player misses one, the level is restarted and one play is used. As the levels advance, the grid may get bigger and the cells change color faster. There may be an option to buy a “slow down” or a skip, where the option may be purchased for money or exchanged for point or turns, although not limited thereto.

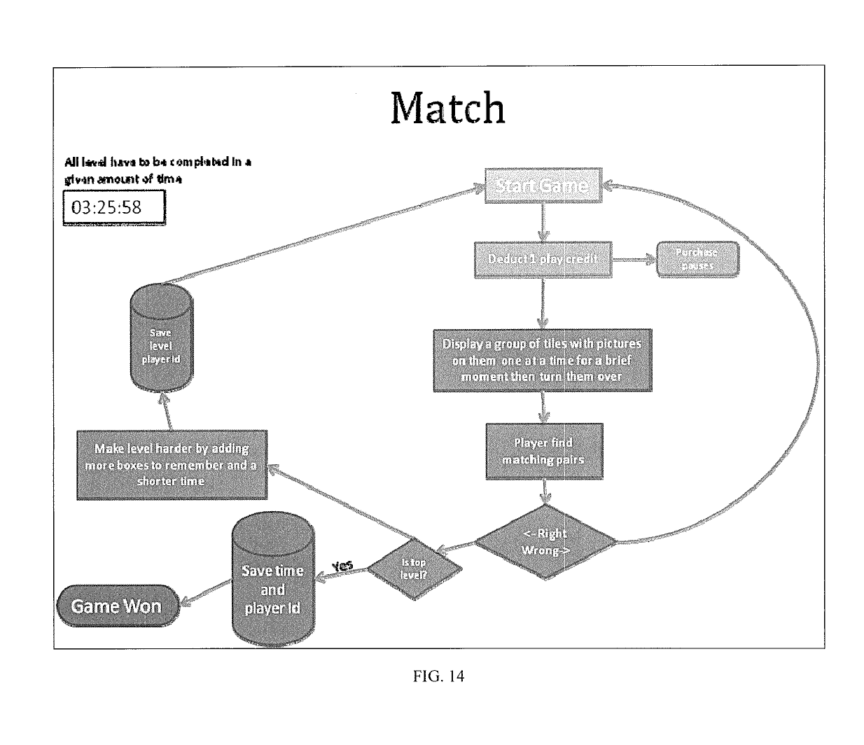

Referring to FIG. 14, another game that may be played includes a game called “Match.” In this game, the play may be similar to “Memory,” except the players have to match the pictures in the boxes, where each advancing level increases the number of items to match. A reducer may be purchased using plays to reduce the number of matches for a certain time.

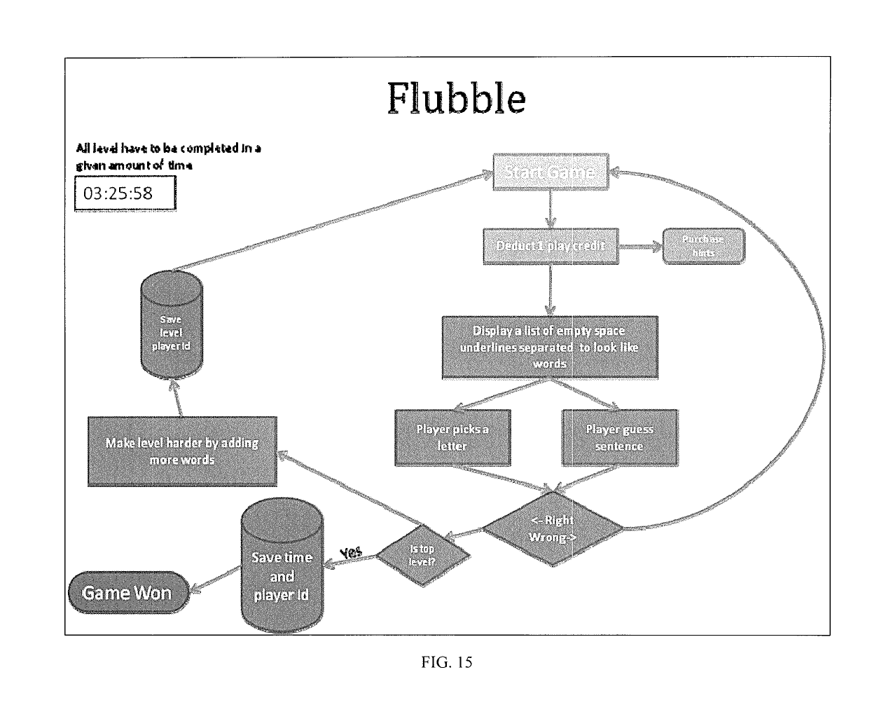

Referring to FIG. 15, another game that may be played includes a game called “Flubble.” In this game, a group of letters may be presented to a player and all of the letters displayed in a mixed or jumbled fashion. The idea is to spell out a sentence with these letters. Blank, underlined, or boxed spaces may be displayed that show which letters should go there. The player may be able to buy hints for money or turns. The first player to get the whole sentence correct may win.

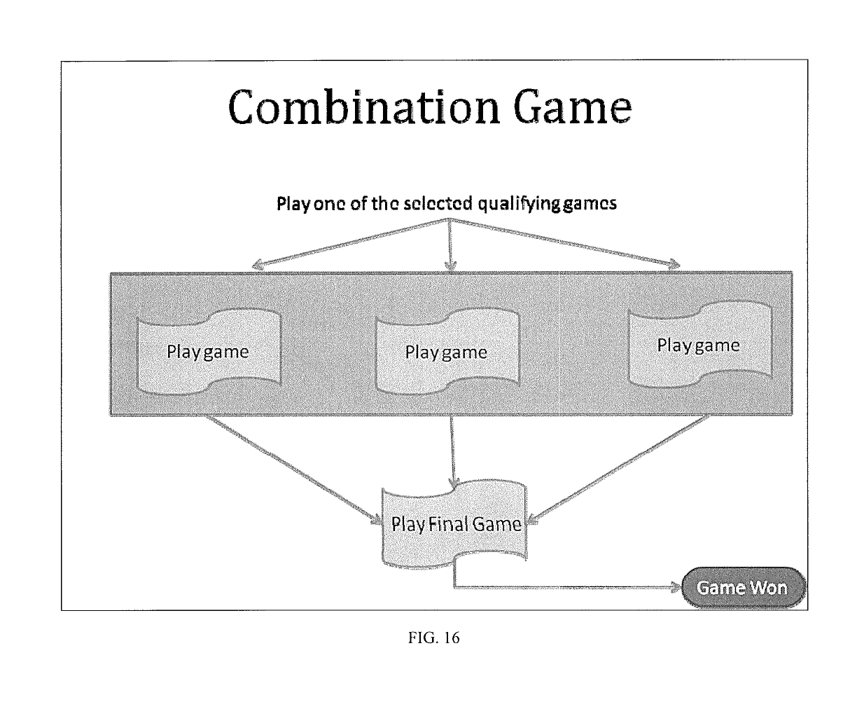

Referring to FIG. 16, still another game that may be played includes a game called “Combination Game.” In this game, a player may be allowed to pick any one of a number of games, where each game may have different skill levels or levels of difficulty.

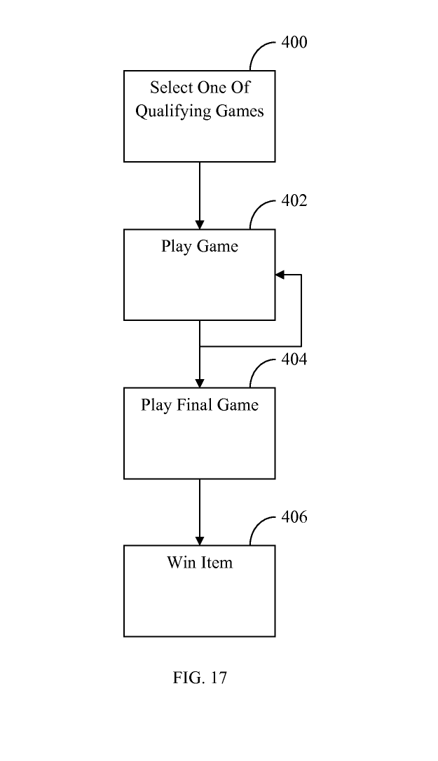

Referring now to FIG. 17, shown is a block diagram depicting one embodiment of a method playing a combination game according to the system of FIG. 1. The player may select a qualifying game 400, play the game 402, play a final game 404, and win an item 406. When the player wins the game selected, they will then have to play the main (e.g., final) game. Any of the games described herein may be used as part of the combination game. In that case, the word “win” means they won that game and then may play the main game.

In accordance with the present invention, the processing of the method of the invention may be implemented, wholly or partially, by a controller (e.g., computer, processing device, etc.) operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combinations comprising at least one of the foregoing.

Moreover, the method of the present invention may be embodied in the form of a computer or controller implemented processes. The method of the invention may also be embodied in the form of computer program code containing instructions embodied in tangible media, such as floppy diskettes, CDROMs, hard drives, and/or any other computer-readable medium, wherein when the computer program code is loaded into and executed by a computer or controller, the computer or controller becomes an apparatus for performing the method.

The present teachings may also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of any appended claims and their legal equivalents, as understood by those of skill in the art relying upon the disclosure in this specification and the attached drawings. Moreover, unless specifically stated any use of the terms first, second, etc. do not denote any order or importance, but rather the terms first, second, etc. are used to distinguish one element from another.

What is claimed is:

1. A system for marketing a product, comprising:
a storage having information on a plurality of games and information on a plurality of prizes;
a server computer in electronic communication with the storage;
storer software executing on the server computer receiving information on a submitted prize over a network and storing it in the storage as one of the plurality of prizes;
value assigner software executing on the server computer assigning a monetary value to each of the plurality of prizes;
prize offer software executing on the server computer offering the plurality of prizes to a plurality of players;
ticket seller software executing on the server computer selling tickets to the plurality of players for the chance to win a selected prize of the offered plurality of prizes, the ticket seller software using the monetary value associated with the selected prize to calculate a preferred number of tickets to sell, each of the tickets having at least one game play;
game offering software offering at least one of the plurality of games for play in return for at least one game play; and
winner identifier software identifying a winner of the selected prize based at least in part on results of the play of the at least one of the plurality of games.

2. The system of claim 1 wherein the storage comprises a plurality of databases in electronic connection with each other.

3. The system of claim 1 wherein the server computer comprises a plurality of computers in electronic connection with each other.

4. The system of claim 1 further comprising submitter software executing on a submitter computer, the submitter software sending the information on the submitted prize to the storer software.

5. The system of claim 1 further comprising at least one web page having a graphical user interface for the prize offer software, ticket seller software and game offering software.

6. The system of claim 1 further comprising a mobile device application executing on a player computer, the mobile device application having a graphical user interface for the prize offer software, ticket seller software and game offering software.

7. The system of claim 1 wherein the value assigner software determines the monetary value based on one or more attributes of the submitted prize.

8. The system of claim 1 wherein the monetary value includes an administrator fee.

9. The system of claim 1 wherein the game offering software does not offer the at least one of the plurality of games for play until the preferred number of tickets are sold.

10. The system of claim 1 further comprising approver software executing on an approver computer, the approver software approving the information on the submitted prize so that the submitted prize can be offered by the prize offerer software.

11. The system of claim 10 wherein the approver computer and the server computer comprise different computers.

12. The system of claim 1 wherein the at least one of the plurality of games comprises a plurality of games offered in a plurality of rounds.

13. The system of claim 12 wherein different games are played in each of the plurality of rounds.

14. The system of claim 12 wherein a player can skip a round in return for paying an additional fee.

15. The system of claim 1 wherein players pay additional fees for game hints, to play an easier game, or for bonus features.

16. The system of claim 1 wherein the tickets have an expiration date before which their associated game plays must be used.

17. The system of claim 1 wherein the monetary value of the submitted prize is provided by the prize owner.

18. A system for marketing a product, comprising:
a storage having information on a plurality of games and information on a plurality of prizes;
a server computer in electronic communication with the storage;
storer software executing on the server computer receiving information on a submitted prize over a network and storing it in the storage as one of the plurality of prizes;
submitter software executing on a submitter computer, the submitter software sending the information on the submitted prize to the storer software;
value assigner software executing on the server computer assigning a monetary value to each of the plurality of prizes;
prize offer software executing on the server computer offering the plurality of prizes to a plurality of players;
ticket seller software executing on the server computer selling tickets to the plurality of players for the chance to win a selected prize of the offered plurality of prizes, the ticket seller software using the monetary value associated with the selected prize to calculate a preferred number of tickets to sell, each of the tickets having at least one game play;
game offering software offering at least one of the plurality of games for play in return for at least one game play;
at least one web page having a graphical user interface for the submitter software, prize offer software, ticket seller software and game offering software; and
winner identifier software identifying a winner of the selected prize based at least in part on results of the play of the at least one of the plurality of games.

19. A method for marketing a product, comprising the steps:
storing on a storage information on a plurality of games and information on a plurality of prizes;
providing a server computer in electronic communication with the storage;
receiving information on a submitted prize over a network and storing it in the storage as one of the plurality of prizes;
assigning a monetary value to each of the plurality of prizes;
offering the plurality of prizes to a plurality of players;
selling tickets to the plurality of players for the chance to win a selected prize of the offered plurality of prizes using the monetary value associated with the selected prize to calculate a preferred number of tickets to sell, each of the tickets having at least one game play;
offering at least one of the plurality of games for play in return for at least one game play; and
identifying a winner of the selected prize based at least in part on results of the play of the at least one of the plurality of games.

20. The method of claim 19 further comprising the step of sending the information for the submitted prize from a submitter computer.

21. The method of claim 19 further comprising the step of approving the information on the submitted prize so that the submitted prize can be offered by the prize offerer software.

22. The method of claim 19 wherein the at least one of the plurality of games comprises a plurality of games offered in a plurality of rounds.

23. The method of claim 19 wherein the step of offering at least one of the plurality of games for play does not occur until the preferred number of tickets are sold.
